(19) United States
(12) Patent Application Publication
(10) Pub. No.: US 2005/0067382 A1
(43) Pub. Date: Mar. 31, 2005

(54) Fine pitch electronic flame-off wand electrode

(76) Inventors: Gary Gillotti, Lansdale, PA (US); Horst Clauberg, North Wales, PA (US); John Shuhart, Warminster, PA (US)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(21) Appl. No.: 10/948,905

(22) Filed: Sep. 24, 2004

Related U.S. Application Data
(60) Provisional application No. 60/506,269, filed on Sep. 26, 2003.

(51) Int. Cl. B23K 11/16

(52) U.S. Cl. 219/56.21

(57) ABSTRACT

An electrode for use in a wire bonding apparatus is constructed of substantially pure iridium or an iridium alloy. The electrode also has a diameter that is chosen to aid in the self-cleaning of an end of the electrode during the electronic flame-off process.

### CROSS-REFERENCE TO RELATED APPLICATION

The present application claims priority from U.S. Provisional Application No. 60/506,269, filed Sep. 26, 2003, which is incorporated herein by reference in its entirety.

### FIELD OF THE INVENTION

The invention relates to the field of wire bonding, and particularly to electrodes used in a wiring bonding process.

### BACKGROUND OF THE INVENTION

A conventional wire bonding apparatus 100 is depicted in FIG. 1. The apparatus includes an electrical flame-off (EFO) wand 104, a bonding wire 108, which is fed through a wire damper 112 and a capillary 116. The wire damper 112 and the capillary 116 are typically referred to collectively as a bond head assembly. A ball 120 is formed at the end of the wire 108 that protrudes from the narrow end of the capillary 116. The apparatus 100 also includes a lead frame 122 having leads 124 and 128. A semiconductor integrated circuit or die 132 is mounted on the lead frame 122 and forms die-lead frame assembly. The die 132 includes bond pads 136 and 140. A wire 144 is bonded to the pad 140 and the lead 124. The apparatus 100 also includes a lead frame holder 148, which secures the die-lead frame assembly during wire bonding, and an electrical discharge generator 152 coupled to the wire damper 112 and the EFO wand 104. The electrical discharge generator creates an electrical discharge in response to receiving a discharge signal.

Bonding the wire 108 to the die 140 and the lead frame 122 is accomplished using the bond head. The bond head generally moves in the x, y, and z directions above the die-lead frame assembly.

Conventionally, the ball 120 on the end of the wire 108 is formed by placing the electrical flame-off (EFO) wand 104 a predetermined distance from the end of the wire 108. An electrical arc is emitted between the end of the wire 108 and the EFO wand 104. The arc forms the ball 120 on the end of the spool of bonding wire 108. By varying the intensity and the duration of the electrical arc, the size of the ball that is formed can be adjusted to specific dimensions.

FIG. 2 depicts a prior art EFO wand 104, which includes a mounting section 164, epoxy 168, and an electrode 172. The mounting section 164 is both rigid and electrically conductive. The epoxy 168 is electrically conductive and secures the electrode 172 to the mounting section 164. As discussed above, the electrode 172 emits an electrical discharge or arc from a tip 176 to the end of a bonding wire 108 to form a ball 120. The electrode 172 is formed from a rigid and electrically conductive material. Typical electrodes 174 are made of platinum having a purity of 99.95%. The diameter of a typical electrode is 0.020 inches.

It has been determined that, during use, a certain amount of carbon contamination forms on the EFO electrode each time a bonding ball 120 is formed. The carbon contamination acts as an insulator. As such, build up of carbon contamination interferes with the normal functioning of the electrode tip 176. As the carbon contaminates the electrode, it gradually degrades the quality of the bonding balls that are formed.

Mechanical scraping of the electrode tip 176 is one possible method of removing the contamination which has been deposited. However, this method has serious drawbacks in that continual mechanical adjustments would be required to avoid excessive damage to electrode tip 176. Additionally, the mechanical apparatus needed to scrape the electrode tip would need to be located on the automated ball bonding machinery near the normal operating position of the electrode 172, a location where space is already at a premium. Therefore, a need exists for an electrode with self-cleaning features.

### SUMMARY OF THE INVENTION

The invention relates to an electrode for use in a wiring bonding apparatus. The electrode is constructed of iridium or an iridium alloy, and has a diameter of a predetermined value. In various embodiments, the iridium alloy is a mixture of iridium and at least one other material such as rhodium, platinum, ruthenium, palladium, molybdenum, and tungsten. For example, the iridium alloy can be approximately 99 weigh percent iridium and 1 percent rhodium. In a preferred embodiment, the iridium alloy can be 80 weight percent iridium and approximately 20 weight percent rhodium. Alternatively, substantially pure iridium can be used. The diameter of the electrode is less than 0.020 inches and may be approximately 0.010 inches. In one embodiment, the electrode includes an insulating layer disposed on the iridium alloy. The insulating layer can be glass or another suitable material.

In another aspect, the invention is directed to an electronic flame-off wand assembly having a mounting section and an electrode. The mounting section is fabricated of an electrically conductive material and has a bore of a first diameter through a portion of the section. The electrode has a second diameter and is disposed within the bore of the mounting section. The electrode is fabricated of an iridium alloy as described above.

The foregoing and other features of the invention and advantages of the present invention will become more apparent in light of the following detailed description of the preferred embodiments, as illustrated in the accompanying figures. As will be realized, the invention is capable of modifications in various respects, all without departing from the invention. Accordingly, the drawings and the description are to be regarded as illustrative in nature, and not as restrictive.

### BRIEF DESCRIPTION OF THE DRAWINGS

For the purpose of illustrating the invention, there is shown in the drawings a form which is presently preferred; it being understood, however, that this invention is not limited to the precise arrangements and instrumentalities shown. The drawings are not necessarily to scale, emphasis instead being placed on illustrating the principles of the present invention.

FIG. 1 is a prior art prior art wire bonding apparatus.

FIG. 2 is an electrode used in the apparatus of FIG. 1.

FIG. 3 is an electronic flame-off wand incorporating an electrode constructed according to the principles of the present invention.

FIGS. 4A, 4B, and 4C are electrodes constructed according to the principles of the present invention.

FIG. 5 is an embodiment of the electrode of FIG. 4 having an insulative layer disposed thereon.

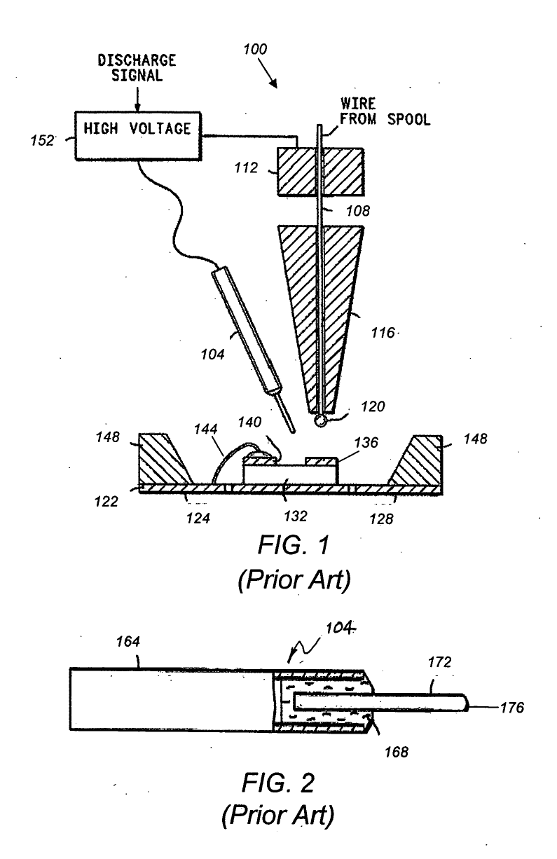

### DETAILED DESCRIPTION OF THE PREFERRED EMBODIMENTS

In the drawings, in which like numerals indicate like elements, there is shown an electrode for use in a wire bonding apparatus and an EFO wand assembly including an electrode constructed according to the principles of the present invention.

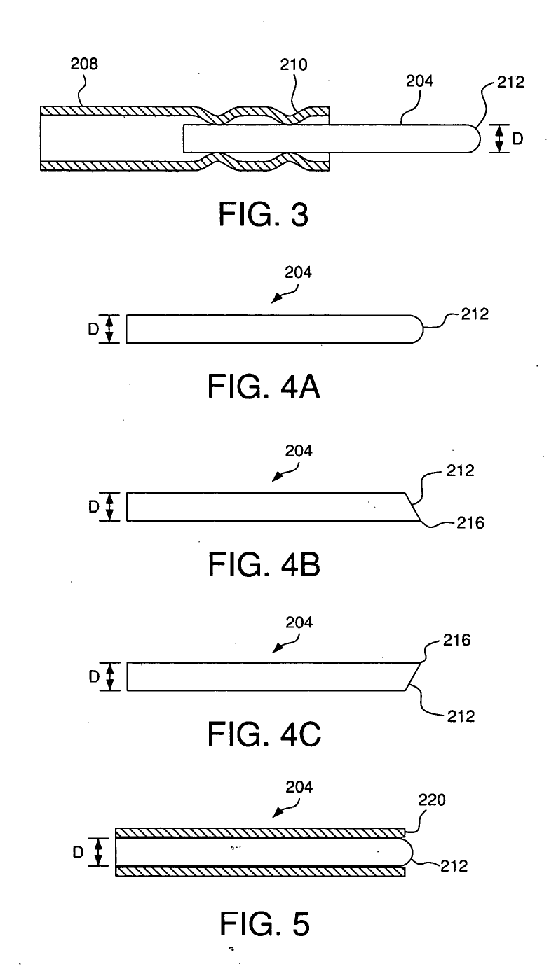

FIG. 3 illustrates an EFO wand 200 that incorporates an electrode 204 constructed according to the principles of the present invention. The wand 200 includes a mounting section 208 and the electrode 204. The mounting section 208 is preferably rigid and electrically conductive. In one embodiment, the mounting section 208 is made from stainless steel. The mounting section 208 is preferably a tube having an inner diameter of sufficient size to receive the electrode 204, which has an outer diameter, D. Preferably, the mounting section 208 is secured to the electrode 204 by crimping an end portion 210 of the mounting portion 208 as shown. It is not a requirement of the invention, however, that the mounting portion is secured to the electrode by crimping. Any suitable means could be used to secure the mounting portion 208 instead of crimping, such as adhesive, fastening, welding and the like.

The electrode 204 is mounted into the bore of the mounting section 208 such that a tip 212 of the electrode 208 is exposed outside the mounting section 208. The electrode 204 is in electrical communication with the mounting section 208 and emits an electrical discharge or arc from the tip 212. The arc forms a ball at the end of the bonding wire.

With reference to FIGS. 4A, 4B and 4C, the electrode is shown in more detail. The electrode 204 is preferably formed from rigid construction and is electrically conductive. In one embodiment, the electrode is fabricated out of substantially pure iridium. In another embodiment, the electrode is fabricated out of an iridium alloy. The iridium alloy is a mixture of iridium and at least one other material such as rhodium, platinum, ruthenium, palladium, molybdenum, and tungsten. In one embodiment, the mixture is approximately 50 weight percent iridium and approximately 50 weight percent rhodium. In a preferred embodiment, the alloy is approximately 80 weight percent iridium and approximately 20 weight percent rhodium. However, depending on the use and efficiency desired, the combination of iridium and rhodium may include a percentage iridium between approximately 50% to 99% or more.

The diameter of the electrode 204 can vary depending on the desired result. In one embodiment, diameter of the electrode 204 is less than approximately 0.020 inches. In a preferred embodiment, the diameter of the electrode 204 is approximately 0.010 inches. It should be readily apparent that the electrode may range in diameter from approximately 0.010 to 0.020 inches. The tip 212 can vary in shape. It is desirable that the tip 212 not be blunt. In one embodiment, the tip 212 is rounded. In alternate embodiments the tip 212 is cut at an angle (e.g., 45 degrees) to create a point 216.

An electrode constructed of an iridium alloy containing 80 weight percent iridium and 20 weight percent rhodium with a diameter of 0.010 inches having a rounded tip provides various advantages in wire bonding applications. The iridium alloy is harder and stiffer (i.e., it has a higher modulus) than a conventional platinum electrode. The harder iridium alloy increases the operational life of the electrode since the harder alloy is less easily damaged and less susceptible to electrical wear. In some applications, such an electrode is capable of forming in excess of twenty million balls on the end of the bonding wire before requiring replacement. Conventional electrodes typically are capable of forming one million balls before maintenance must be performed due to the contamination build up. Also conventional electrodes must be “burned-in” by creating as many as 100,000 balls before optimal performance of the electrode is achieved.

The smaller diameter of 0.010 is also a factor in extending the usability of the electrode 204. A smaller diameter electrode reduces the surface area of the tip 212. During the arcing process, a small amount of plasma is created on the tip of the electrode. The plasma acts as a cleanser to assist in removing a portion of the oxidation that forms on the tip. In the present invention, the reduced tip surface area means that the plasma removes a larger amount of the oxidized material. As a result, a greater surface area of the tip 212 is self-cleaned. A clean tip electrode yields more consistent ball diameters on the end of the wire during the wire bonding processes.

With reference to FIG. 5, in another embodiment a layer of insulative material 220 is disposed on the iridium alloy. In such an embodiment, it is preferred that the tip 212 be rounded. The insulative layer 220 constrains the plasma field during the arcing time. The constrained plasma field concentrates the spark to a limited location on the electrode 204. As such, the plasma that is generated as close as possible to the tip, which is where the oxidation occurs. Thus the insulative material 220 increased the cleansing provided by the electrode, thereby producing more consistent balls over the life of the electrode. In one embodiment, the insulative material is a layer of glass having a thickness of approximately 0.002 inches. Alternatively, other materials such as, oxides, nitrides, silica, alumina, and other ceramics can be used. Additionally, high temperature polymers such as polyimide, bisbenzocyclobutene, polysulfones, and phenolics can be used.

The narrower tip that is provided in the present invention through the use of the iridium materials also permits the electrode to be positioned closer to the bonding location than is possible using prior electrodes. Furthermore, the smaller tip is also lighter than conventional electrodes, thus reducing the weight of the entire bonding assembly.

As noted above, a variety of modifications to the embodiments described will be apparent to those skilled in the art from the disclosure provided herein. Thus, the present invention may be embodied in other specific forms without departing from the spirit or essential attributes thereof and, accordingly, reference should be made to the appended claims, rather than to the foregoing specification, as indicating the scope of the invention.

1. An electrode for use in a wire bonding apparatus, the electrode comprising:
iridium having a diameter of a predetermined value.

2. The electrode of claim 1 wherein the iridium further comprises at least one other material in addition to the iridium to form an iridium alloy.

3. The electrode of claim 2 wherein the at least one other material is selected from the group consisting of rhodium, platinum, ruthenium, palladium, molybdenum, and tungsten.

4. The electrode of claim 2 wherein the iridium alloy comprises approximately 80 weight percent iridium and approximately 20 weight percent rhodium.

5. The electrode of claim 1 wherein the diameter is less than approximately 0.020 inches.

6. The electrode of claim 1 wherein the diameter is approximately 0.010 inches.

7. The electrode of claim 2 further comprising an insulating layer disposed on the iridium alloy.

8. The electrode of claim 7 wherein the insulating layer comprises glass.

9. An electronic flame-off wand assembly comprising:
a mounting section comprising an electrically conductive material having a bore of a first diameter therein; and
an electrode having a second diameter disposed within the bore of the mounting section, the electrode comprising iridium.

10. The assembly of claim 9 wherein the electrode comprises at least one material in addition to the iridium to form an iridium alloy, wherein the at least one material is selected from the group consisting of rhodium, platinum, ruthenium, palladium, molybdenum, and tungsten.

11. The assembly of claim 10 wherein the iridium alloy comprises approximately 80 weight percent iridium and approximately 20 weight percent rhodium.

12. The assembly of claim 9 wherein the diameter of the electrode is less than approximately 0.020 inches.

13. The assembly of claim 9 wherein the diameter of the electrode is substantially 0.010 inches.

14. The assembly of claim 9 further comprising an insulating layer disposed on the iridium.

15. The assembly of claim 14 wherein the insulating layer comprises glass.

16. An electronic flame-off wand assembly comprising:
a stainless steel mounting section having a bore therein; and
an iridium alloy electrode having a diameter of approximately 0.010 inches disposed within the bore of the mounting section, the iridium alloy comprising 80 weight percent iridium and 20 weight percent rhodium.

17. The assembly of claim 16 further comprising an insulating layer disposed on the iridium alloy.

18. The assembly of claim 17 wherein the insulating layer is selected from the group consisting of glass, oxides, nitrides, silica, alumina, ceramics, and high temperature polymers.
